(19) United States
(12) Patent Application Publication
(10) Pub. No.: US 2025/0021992 A1
(43) Pub. Date: Jan. 16, 2025

(54) SYSTEM AND METHOD FOR USING A NON-FUNGIBLE TOKEN TO OPTIMIZE A CHARITABLE DONATION

(71) Applicant: CHRISTMAS GERARD HOLDINGS, LLC, DENVER, CO (US)

(72) Inventor: CHRIS CHRISTMAS, DENVER, CO (US)

(21) Appl. No.: 18/773,043

(22) Filed: Jul. 15, 2024

Related U.S. Application Data
(60) Provisional application No. 63/513,398, filed on Jul. 13, 2023.

(51) Int. Cl. G06Q 30/018

(52) U.S. Cl. CPC G06Q 30/018; G06Q 2220/00

(57) ABSTRACT

A method includes: generating, using input received at a corresponding interface, a smart contract, the smart contract being configured to define, for at least one party of the smart contract, obligations for performing one or more tasks; generating, in response to receiving a first data object indicating competition of a corresponding task of the one or more tasks, at least one non-fungible token; receiving a second data object indicating that an obligation associated with the corresponding task has been performed by the at least one party of the smart contract; and transmitting, based on the second data object, the at least one non-fungible token to a computing device associated with the at least one party of the smart contract.

### CROSS REFERENCE TO RELATED APPLICATIONS

This U.S. Non-Provisional Patent Application claims the benefit of and priority to U.S. Provisional Patent Application Ser. No. 63/513,398, filed on Jul. 13, 2023 titled “A System And Method For Using A Non-Fungible Token To Optimize A Charitable Donation,” the entire disclosure of which is hereby incorporated by reference.

### TECHNICAL FIELD

This disclosure relates to non-fungible tokens and in particular in particular to generating a non-fungible token to optimize the charitable donation.

### BACKGROUND

Blockchain, although relatively new, is known for its use with documenting a history of an item or transaction. Blockchain verifies that transaction and history ownership of an item, most commonly bitcoin. It is also known to be used to verify authenticity of documents such as a deed for land. Further, it has enabled the use of smart contracts (e.g., contracts which run when predetermined conditions are met, as certified by the blockchain).

While many donors to charities give to obtain desired results, support medical research, feed the homeless, provide medical care to the poor; there is no current way, other than to actually travel to the recipients of charity to confirm that a donor's funds are used as intended. One must rely on aggregated annual reports and assume they are true.

### SUMMARY

An aspect of the disclosed embodiments includes a system for tracking the use of funds by a charity includes a charitable computer. The charitable computer is configured to create a smart contract, the smart contract requiring the completion of one or more charitable tasks as a function of monies received. The charitable computer creating a non-fungible token at the completion of each of the one or more charitable tasks. One or more donor computers are configured to transfer funds to the charitable computer as a function of the one or more charitable tasks. The charitable computer transferring the non-fungible token to the donor computer upon completion of each of the one or more charitable tasks.

In some embodiments, the charitable computer is configured to transmit an airdrop to the one or more donor computers as function of a completion of all of the one or more charitable tasks identified in the smart contract.

In some embodiments, the smart contract enables transfer of the one or more non-fungible tokens to one or more third party computers in exchange for a transfer of funds to the charity.

Another aspect of the disclosed embodiments includes a system comprising: a processor; and a memory including instructions that, when executed by the processor, cause the processor to: generate, using input received at a corresponding interface, a smart contract, the smart contract being configured to define, for at least one party of the smart contract, obligations for performing one or more tasks; generate, in response to receiving a first data object indicating competition of a corresponding task of the one or more tasks, at least one non-fungible token; receive a second data object indicating that an obligation associated with the corresponding task has been performed by the at least one party of the smart contract; and transmit, based on the second data object, the at least one non-fungible token to a computing device associated with the at least one party of the smart contract.

Another aspect of the disclosed embodiments includes a method comprising: generating, using input received at a corresponding interface, a smart contract, the smart contract being configured to define, for at least one party of the smart contract, obligations for performing one or more tasks; generating, in response to receiving a first data object indicating competition of a corresponding task of the one or more tasks, at least one non-fungible token; receiving a second data object indicating that an obligation associated with the corresponding task has been performed by the at least one party of the smart contract; and transmitting, based on the second data object, the at least one non-fungible token to a computing device associated with the at least one party of the smart contract.

These and other advantages and features will become more apparent from the following description taken in conjunction with the drawings.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a block diagram of a system for enabling use of the non-fungible token based smart contract to track use of charitable giving according to the principles of the present disclosure.

FIG. 2 is a flowchart generally illustrating a charitable giving method according to the principles of the present disclosure.

FIG. 3 generally illustrates a computing device according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As used herein, (1) a Smart Contract includes a contractual agreement between parties to be validated prior to the transfer of funds between parties to the smart contract, (2) a Charitable Computer ides a computing device associated with an entity responsible for validating the completion of a given charitable task associated with the social determinants of health and dimensions of wellness within a smart contract, (3) a Donor Computer includes a computing device associated with an Entity responsible for transferring funds based on the authentication that a given charitable task within a smart contract has been completed, (4) an Air drop includes an incremental addition of funds made available as a result of the authentication of a completed charitable task associated with the social determinants of health and dimensions of wellness within a smart contract, and (5) a Charitable Task—includes measurable tasks linked to applicable social determinants of health and dimensions of wellness to be completed by a recipient of charitable donations (Donee) resulting from consumer purchases of products, goods and services and made payable to the charity for the benefit of the recipient (Donee).

The present disclosure is directed to a structure and method for utilizing blockchain technology and more particularly for using encrypted information in the form of a cyberlabel linked to a non-fungible token (“NFT”) to confirm satisfaction of charitable tasks to enable measurable outcomes using the appropriate dimension of wellness and social determinants of health and subsequent use of donated funds by a public or private charity to address various social causes, and to provide a continued, and to provide a continued revenue stream based on consumer purchases of designated products, goods, and services, and to provide a continued revenue stream to that charity without requiring additional monetary contributions to be made direct by the original donor.

While donors to charities seek measurable outcomes tied to user data, it is oftentimes difficult to define and leverage meaningful activities to measure progress to achieving these outcomes. Using the dimensions of wellness and the social determinants of health as the basis of measuring progress, both donor and recipient of charitable contributions (Donee) are better able to incrementally capture, aggregate, analyze, report data and jointly implement remedies or other corrective actions, where necessary, to achieve intended outcomes.

In some embodiments, the systems and methods described herein may be configured to provide a block chain enabled methodology leveraged to define the parties involved in a transaction via metadata, authenticate parties involved in transactions, and provide enforceable agreements among parties involved in transactions.

In some embodiments, a system and method are provided for making use of the a smart contract (e.g., which may be referred to as an enforceable contract) linked to NFTs, and the appropriate dimension(s) of wellness and social determinant(s) of health, and the use of non-fungible blockchain based token to raise funds for charitable purposes through consumer purchases of products, goods and services while only putting the token or underlying products, goods, and services at risk, to overcome the shortcomings of the prior art, is provided.

The enforceable contract is called a ‘smart contract’ which facilitates a secure, flexible, and user friendly methodology for concurrent user authentication, validation that social determinants of health and dimensions of wellness have been satisfied by the donee, the social impacts of the brand producer can be identified, measured and reported, and the brand producer defined tax deductible allocation of funds from each sale are transferred to the designated donor for subsequent transfer to the donee.

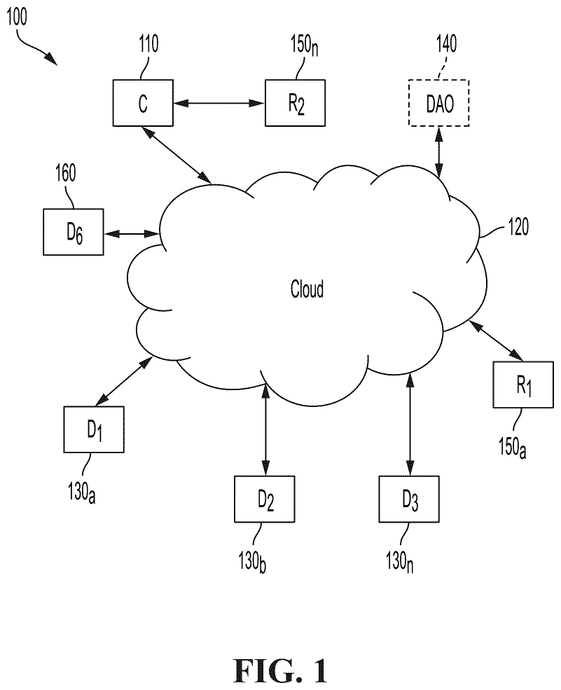

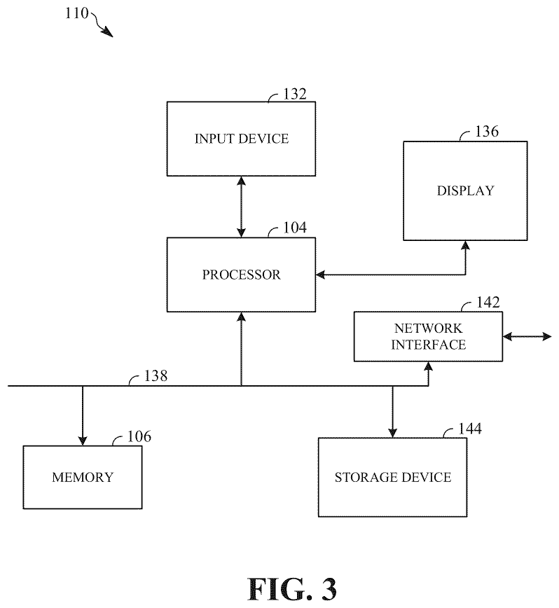

Reference is now made to FIGS. 1 and 3 in which system 100 for enabling the tracking of charitable giving with one or more non-fungible token(s) (“NFT”) creating smart contracts in provided. System 100 includes a computing device 110 (e.g., which may be referred to herein as the computing device 110, the charitable computing device 110, and/or the charitable computer 110). The computing device 110 may include any suitable computing device including a mobile computing device (e.g., a smart phone, tablet, or other suitable mobile computing device), a laptop-computing device, a desktop computing device, or any other suitable computing device. The computing device 110 may include a processor 104 and a memory 106. The processor 104 may include any suitable processor, such as those described herein. Additionally, or alternatively, the computing device 110 may include any suitable number of processors, in addition to or other than the processor 104. The memory 106 may comprise a single disk or a plurality of disks (e.g., hard drives), and includes a storage management module that manages one or more partitions within the memory 106. In some embodiments, memory 106 may include flash memory, semiconductor (solid state) memory or the like. The memory 106 may include Random Access Memory (RAM), a Read-Only Memory (ROM), or a combination thereof. The memory 106 may include instructions that, when executed by the processor 104, cause the processor 104 to, at least, perform the functions associated with the systems and methods described herein.

The computing device 110 may include a user input device 132, as is generally illustrated in FIG. 3, which may be configured to receive input from a user of the computing device 110 and to communicate signals representing the input received from the user to the processor 104. For example, the user input device 132 may include a button, keypad, dial, touch screen, audio input interface, visual/image capture input interface, input in the form of sensor data, etc.

The computing device 110 may include a display 136 that may be controlled by the processor 104 to display information to a user. A data bus 138 may be configured to facilitate data transfer between, at least, a storage device 144 and the processor 104. The computing device 110 may also include a network interface 142 configured to couple or connect the computing device 110 to various other computing devices or network devices via a network connection, such as a wired or wireless connection, or other suitable connection. In some embodiments, the network interface 142 includes a wireless transceiver.

The storage device 144 may comprise a single disk or a plurality of disks (e.g., hard drives), one or more solid-state drives, one or more hybrid hard drives, and the like. The storage device 144 may include a storage management module that manages one or more partitions within the storage device 144. In some embodiments, storage device 144 may include flash memory, semiconductor (solid state) memory or the like.

In some embodiments, the charitable computer 110 may be configured to create a smart contract. The charitable computer 110 may be configure to execute programs stored on a blockchain in response to one or more predetermined conditions of the smart contract being met. The smart contract may be used (e.g., by the charitable computer 110 or other suitable computing device) to automate the execution of an agreement such that all participants (e.g., which may be referred to herein as parties) can be immediately or substantially immediately certain of an outcome of one or more charitable tasks, without involvement intermediary or without the intermediary losing time.

The smart contract may be entered into by a charity using charitable computer 110 at one end and one or more donors, D₁-D₃ at donor computers 130ₐ-130ₙ, each communicating via a remote computing system or device, such as cloud 120 and/or any other suitable remote computing device. The donor computers 130ₐ-130ₙ may include features similar to and/or different from the computing device 110. One or more of the donor computers 130ₐ-130ₙ may be configured to perform a smart contract.

In some embedment's, the charity computer 110 may be configured to create and transmit one or more NFTs to one or more donors computers 130 in compliance with the smart contract. In some embodiments, a decentralized autonomous organization (“DAO”) 140 may operate on behalf of two or more donors to execute and participate in the smart contract.

In some embodiments, the system 100 and/or the computing device 110 may perform the methods described herein. However, the methods described herein as performed by the system 100 and/or the computing device 110 are not meant to be limiting, and any type of software executed on a controller can perform the methods described herein without departing from the scope of this disclosure. For example, a controller, such as a processor executing software within a computing device, can perform the methods described herein.

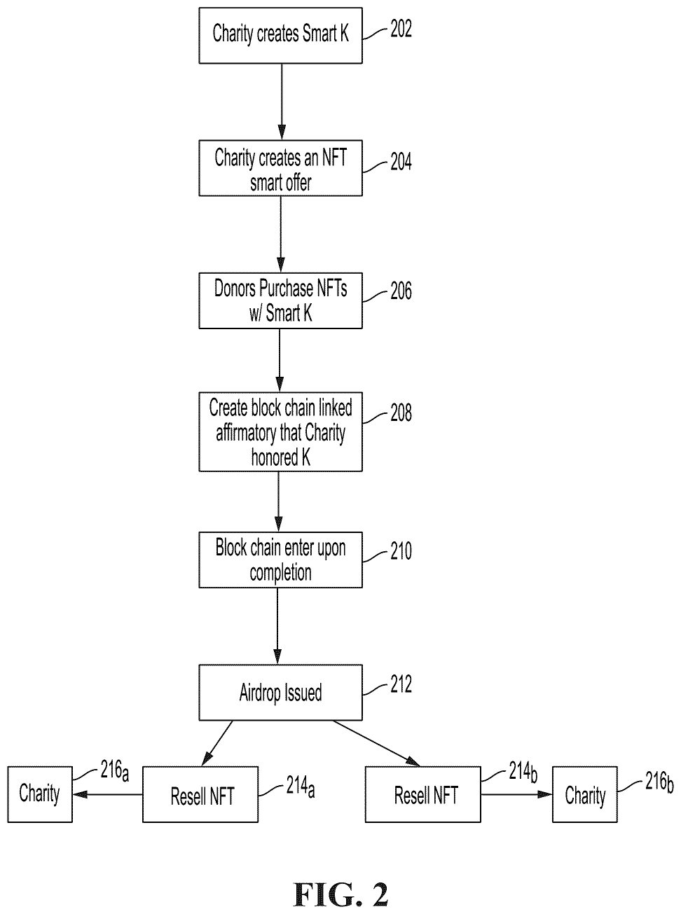

FIG. 2 generally illustrates a method 200, according to the principles of the present disclosure. At 202, the method 200 uses the charitable computer 110 (e.g., which may be associated with charity C) to generate a smart contract for soliciting funds online for specific charitable activities and/or purposes. The computing device 110 may be configured to, responsive to input by the charity C, issue and/or provide an NFT associated object to the donor associated with at least one donor computer 130 (e.g., where the donor is a party of the smart contract).

The smart contract includes at least one term that an NFT(s) is issued to a donor D as each of the milestones of the charitable activities is met. As a result at 204, the method 200 includes generating an NFT based self-auditing smart contract offer used to solicit funds from potential donors D₁-D₃.

At 206, the method 200, interested donors D₁-D₃ utilizing donor computers 130ₐ-130ₙ purchase NFTs pursuant to the smart contract. The contract may deliver NFTs in stages, as every ten families are delivered food on the way to completion of feeding one hundred families, by way of non-limiting example, until a final NFT is delivered upon completion of the tasks identified in the contract.

The NFTs may be associated with distinct works of art to indicate the completion of each milestone, or may be a single item such as a sneaker, or logo, which changes color upon completion of each milestone. In this way a simple, always accessible, status confirmation is provided to the donor 130.

The method 200 may including monitoring, which may be enabled using any suitable technique. Targeted recipients R₁-R₂ of the charitable goods and services may also be a third party beneficiaries to the smart contract, such that upon receipt of the agreed to services or goods, at step 208, the method 200 includes, generating, for a recipient R₁, a blockchain linked affirmation that the charity was received using a computer or smart phone 150n (e.g., or other suitable computing device), which is not smart contract enabled. The charitable computer 110 may self-report the milestone.

Once each of the tasks defined under the smart contract is provided, the charitable computer 110 may transmit a final NFT to donor computer 130 at 210 as a blockchain audited affirmation that charity C honored the contract. This may provide direct, easily accessible affirmation that the bargained for charitable works have been completed.

At step 212, the method 200 distributes, as a reward for participating in the charitable program, an additional NFT or digital asset to a web3 wallet address or other suitable location or storage mechanism of donor D as a promotion, or as added value for participating in the charitable giving as an “Airdrop”. Airdrops are generally used to add additional value or to draw attention to a brand or experience. However, these airdrops are also subject to a smart contract, either the original smart contact or a supplementary one which must be entered as a condition for receiving the airdrop.

The smart contract may allow for the resale of the airdropped NFT and its associated artwork, at step 214a to a donor D_{G}, where donor enabled computer 160 is enabled to process the resell in accordance with the contract, such that the proceeds are sent as a donation to charity C at step 216a. In this way the original donor 130 is provided with a no cost mechanism to solicit additional funds for the charity C. At 214b, 216b, the airdropped NFT may be resold.

In some embodiments, a charity such as Acme Food Shelter (“AFS”) is desirous of soliciting funds to feed the homeless. AFS, at 202 develops a smart contract using smart contract enabled computer 110. The contract includes the term that AFS will serve 300 meals to the homeless for a donation of $300. At 204, computer 110 generates three or more NFTs and using the smart contract offers the NFT to donors for a donation of $300 or more. The donors D enter the contract at donor computers 130 by funding charity C at charity computer 110. Pursuant to the smart contract, at 208, 210 computer 110 confirms that each $100 of meals are distributed to recipients R, and sends transmits an NFT, such as a painting, or an emblematic token such as a religious symbol, from charity computer 110 to donor computer 130 each time that a $100 of charity milestone has been completed. Additionally, or alternatively, the token may merely change color from bronze to silver to gold to indicate each time $100 worth of meals are served.

As a thank you for supporting the full charitable goal, upon completion a bonus NFT, such as a recording of a song donated by a celebrity sponsor of the song is airdropped to donor computer 130 with additional smart contract terms. The terms are that the token may be resold with proceeds being transmitted to charitable computer 130, and charitable computer 110 recognizing the sale as a charitable donation.

As a result of the above described system and method, it becomes possible to associate an NFT with a charitable donation, incentivizing donors to give, while providing an audit trail with the same mechanism. Furthermore, the NFT can change from one form to another, through updating or replacement, as the charitable process progresses. The NFT starts to change to reflect each life step of the NFT and associated charitable activity as discussed above.

In some embodiments, as a result of the inventive linking of the charity issued items and NFT, any donor that wants to be assured of the authenticity of the charitable purpose and deeds can be assured by the interaction of the cyberlabel and NFT as described above. In addition, through the use of blockchained information as discussed above, the charity can participate in a percentage of any subsequent sales because of the tracked and blockchained sales transactions.

It should be noted, that each donor computer and charity computer, while they may be a computer owned by the entity, need not be an actual computer in the possession of a respective party. The definition of computer may also include a computer or server in the cloud on which resides an account, such as a wallet, over which the party has control.

It will thus be seen that the objects set forth above, among those made apparent from the preceding description, are efficiently attained and, since certain changes may be made in carrying out the above method and in the construction set forth without departing from the spirit and scope of the disclosure, it is intended that all matter contained in the above description and shown it the accompanying drawings shall be interpreted as illustrative and not in a limiting sense.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

What is claimed is:

1. A system comprising:
a processor; and
a memory including instructions that, when executed by the processor, cause the processor to:
generate, using input received at a corresponding interface, a smart contract, the smart contract being configured to define, for at least one party of the smart contract, obligations for performing one or more tasks;
generate, in response to receiving a first data object indicating competition of a corresponding task of the one or more tasks, at least one non-fungible token;
receive a second data object indicating that an obligation associated with the corresponding task has been performed by the at least one party of the smart contract; and
transmit, based on the second data object, the at least one non-fungible token to a computing device associated with the at least one party of the smart contract.

2. The system of claim 1, wherein the one or more tasks includes one or more charitable tasks.

3. The system of claim 1, wherein the obligation include transferring a charitable gift.

4. The system of claim 3, wherein transferring the charitable gift includes electronically transferring the charitable gift.

5. The system of claim 1, wherein the at least one non-fungible token is associated with a unique work of art.

6. The system of claim 1, wherein the at least one non-fungible token is associated with a logo.

7. The system of claim 1, wherein the at least one non-fungible token is associated with a digital item.

8. The system of claim 1, wherein the smart contract is registered on a blockchain.

9. The system of claim 1, wherein the instructions further cause the processor to, validate, using a blockchain and the second data object, that the obligation associated with the corresponding task has been performed by the at least one party of the smart contract.

10. The system of claim 9, wherein transmitting, based on the second data object, the at least one non-fungible token to the computing device associated with the at least one party of the smart contract is further based on validating using the blockchain and the second data object, that the obligation associated with the corresponding task has been performed by the at least one party of the smart contract.

11. A method comprising:
generating, using input received at a corresponding interface, a smart contract, the smart contract being configured to define, for at least one party of the smart contract, obligations for performing one or more tasks;
generating, in response to receiving a first data object indicating competition of a corresponding task of the one or more tasks, at least one non-fungible token;
receiving a second data object indicating that an obligation associated with the corresponding task has been performed by the at least one party of the smart contract; and
transmitting, based on the second data object, the at least one non-fungible token to a computing device associated with the at least one party of the smart contract.

12. The method of claim 11, wherein the one or more tasks includes one or more charitable tasks.

13. The method of claim 11, wherein the obligation include transferring a charitable gift.

14. The method of claim 3, wherein transferring the charitable gift includes electronically transferring the charitable gift.

15. The method of claim 11, wherein the at least one non-fungible token is associated with a unique work of art.

16. The method of claim 11, wherein the at least one non-fungible token is associated with a logo.

17. The method of claim 11, wherein the at least one non-fungible token is associated with a digital item.

18. The method of claim 11, wherein the smart contract is registered on a blockchain.

19. The method of claim 11, further comprising, validating, using a blockchain and the second data object, that the obligation associated with the corresponding task has been performed by the at least one party of the smart contract.

20. The method of claim 19, wherein transmitting, based on the second data object, the at least one non-fungible token to the computing device associated with the at least one party of the smart contract is further based on validating using the blockchain and the second data object, that the obligation associated with the corresponding task has been performed by the at least one party of the smart contract.
